(19) United States
(12) Patent Application Publication
(10) Pub. No.: US 2025/0389635 A1
(43) Pub. Date: Dec. 25, 2025

(54) THERMAL COMPENSATION

(71) Applicant: Malvern Panalytical Limited, Worcestershire (GB)

(72) Inventors: Stephen BARKER, Worcestershire (GB); Andrew Byford JONES, Worcestershire (GB); Darrell BANCARZ, Worcestershire (GB)

(73) Assignee: Malvern Panalytical Limited, Worcestershire (GB)

(21) Appl. No.: 19/120,634

(22) PCT Filed: Oct. 13, 2023
(86) PCT No.: PCT/GB2023/052654

§ 371 Date: Apr. 11, 2025

(30) Foreign Application Priority Data
Oct. 14, 2022 (GB) 2215226.8

(51) Int. Cl. G01N 15/1429; G01N 15/14; G01N 15/1434

(52) U.S. Cl. CPC G01N 15/1431; G01N 15/1434; G01N 2015/1493

(57) ABSTRACT

A temperature verification device for checking accuracy of a dynamic light scattering instrument temperature sensor, the temperature verification device comprising: a body configured to be received in the sample cell holder; a calibrated temperature sensor within the body at a position corresponding with a scattering volume of the dynamic light scattering instrument.

### CROSS-REFERENCE TO RELATED APPLICATIONS

This application is a U.S. national stage application under 35 U.S.C. § 371 of International Application No. PCT/GB2023/052654, filed Oct. 13, 2023, which claims the priority of GB Application No. 2215226.8, filed Oct. 14, 2022. The entire contents of each priority application is incorporated herein by reference.

### FIELD OF THE DISCLOSURE

The present invention relates to a method and apparatus for particle characterisation, and more particularly to temperature control in particle characterisation.

### BACKGROUND OF THE DISCLOSURE

A number of techniques for particle characterisation exist in which movement of particles suspended in a diluent fluid is used to infer a particle size, or a size distribution of particles in a sample. Brownian particle motion is influenced by particle size. The diffusion coefficient is consequently related to particle size by the Stokes-Einstein equation.

$$D = \frac{{k}_{B} T}{6 π η r} \qquad ( 1 )$$

Where D is the diffusion coefficient of the particle in the dispersant, k_{B} is Boltzmann's constant, T is the absolute temperature of the dispersant, η is the dynamic viscosity of the dispersant and r is the hydrodynamic radius of the particle.

If the composition of the dispersant is known (which it generally will be), the viscosity as a function of temperature will also be known. Provided the temperature is known, knowledge of the diffusion coefficient will thereby provide the particle size. If there is uncertainty about the temperature, the particle size will also be uncertain.

Furthermore, in addition to temperature being a necessary parameter for particle characterisation founded on particle diffusion, particle properties may be dependent on temperature. For example, the agglomeration properties of certain proteins may be relevant to their pharmaceutical application, and such properties may be strongly temperature dependent. It may be important that the stability of proteins in suspension are understood at very specific temperatures (e.g. fridge storage temperatures and body temperature).

Dynamic Light Scattering (DLS), which is sometimes referred to as photon correlation spectroscopy (PCS), is a technique that detects Brownian particle motion and determines particle properties. In DLS, a light source is used to illuminate a sample comprising particles suspended in a diluent fluid. Light scattered by the particles is detected. The intensity of the scattered light varies over time, due to Brownian motion of the illuminated particles. An autocorrelation function can be determined from the time history of scattering intensity. With knowledge of the scattering vector (normally denoted by q) the diffusion coefficient D can be determined from the autocorrelation function. For example, it can be shown that, for a dilute solution of monodisperse nanoparticles, the normalised autocorrelation function g⁽¹⁾(t) is related to the scattering vector q and diffusion coefficient according to:

$${g}^{( 1 )} ( t ) = exp ( - {q}^{2} Dt ) \qquad ( 2 )$$

The diffusion coefficient can be related to the particle size via the Stokes-Einstein equation (1).

Any technique that relies on characterising Brownian particle motion to determine particle properties via the Stokes-Einstein equation will be sensitive to temperature. In general, DLS instruments include a temperature control system that ensures that the sample has a specific and known temperature so that temperature does not result in errors in the characterisation of the particles.

Although considerable progress has been made in improving the accuracy of temperature control, there is still room for improvement. Minimisation of temperature related errors in particle characterisation is desirable.

### SUMMARY OF THE DISCLOSURE

According to a first aspect, there is provided a system, comprising;
an instrument for particle analysis by dynamic light scattering, comprising;
   a sample cell holder, configured to receive a sample cell, the sample cell for holding a sample comprising particle suspended in a diluent fluid;
   a light source configured to illuminate the sample with a light beam, thereby producing scattered light from the interaction of the light beam with the particles in a scattering region;
   a light detector, configured to detect the scattered light from the scattering region and to output scattering data;
   a temperature sensor, configured to measure a temperature of the sample cell holder;
   a processor configured to receive the scattering data and the measure of temperature of the sample cell holder, and to determine a particle size by performing a dynamic light scattering analysis on the scattering data;
a temperature verification device, comprising:
   a body configured to be received in the sample cell holder;
   a calibrated temperature sensor within the body, arranged to measure a temperature of the scattering volume.

According to a second aspect, there is provided a temperature verification device for checking accuracy of a dynamic light scattering instrument temperature sensor, the temperature verification device comprising:
a body configured to be received in the sample cell holder;
a calibrated temperature sensor within the body at a position corresponding with a scattering volume of the dynamic light scattering instrument.

Positioning the temperature sensor within the body at a position corresponding with a scattering volume of the dynamic light scattering instrument enables a more representative calibration of a dynamic light scattering instrument.

The instrument may comprise a thermal regulator, comprising a heating system and/or cooling system for controlling the temperature of the sample cell holder (and consequently the temperature of the sample).

The thermal regulator may comprise a thermoelectric device. The thermal regulator may be controlled by the processor. The thermal regulator may further comprise at least one heat sink, for rejecting heat from the thermal regulator away from the sample cell holder. The thermal regulator may comprise a heat spreader between the thermoelectric device and the sample cell holder.

Each of the following features may be applicable to either the first aspect or the second aspect.

The calibrated temperature sensor may comprise a thermocouple or a PT100 sensor. The PT100 sensor may comprise a thin film PT00 sensor.

The device may further comprise a printed circuit board, the printed circuit board comprising a plurality of conducting traces connecting the calibrated temperature sensor to a connector exterior to the body.

The body may comprise a cuboidal interior volume. The printed circuit board may be disposed corner to corner in the cuboidal interior volume. The position of the calibrated temperature sensor may be within the cuboidal interior volume. The position of the calibrated temperature sensor may be between 0.5 mm and 20 mm from a floor of the cuboidal interior volume (or between 5 mm and 15 mm).

The plurality of traces may comprise four traces for performing a four wire measurement of a resistance of the temperature sensor. A first pair of the traces may be connected to a first end of the temperature sensor, and a second pair of the traces connected to a second end of the temperature sensor.

The printed circuit board may comprise a U-shaped portion, comprising a first vertical leg, a second vertical leg and a horizontal cross bar between the first and second vertical legs.

The first vertical leg may comprise the first pair of the traces, with the first trace of the first pair of traces patterned on a first side of the first vertical leg, and the second trace of the first pair of traces patterned on a second, opposite, side of the first vertical leg. The second vertical leg may comprise the second pair of the traces, with the first trace of the second pair of traces pattered on a first side of the second vertical leg, and the second trace of the second pair of traces pattered on a second, opposite pair of the second vertical leg.

Each vertical leg may be disposed in a corner of the interior volume of the body.

The printed circuit board may comprise an H-shaped portion, the upper region of the H-shaped portion comprising the U-shaped portion, and the lower legs of the H-shaped portion contacting a bottom surface of the body.

The body may comprise a sample cell of the same type that is usable for performing a dynamic light scattering analysis.

The body may be a cuvette.

The body may be a 12.5 mm square section cuvette, or a 10 mm square section cuvette, or any other shape or size of cuvette.

The cuvette may be a glass or polystyrene cuvette (or any other suitable transparent cuvette material suitable for dynamic light scattering measurements).

The device may comprise a sample analog in which the calibrated temperature sensor is embedded.

The sample analog may have a volume of between 0.5 and 2 ml.

The sample analog may be selected to match a typical sample volume for analysis by DLS in the instrument.

The sample analog may be a liquid. A liquid sample analog may make handling of the device more difficult, and errors may be introduced if the liquid is displaced. The sample analog may comprise a solid phase polymeric material. The material could be a non-polymer, provided it had suitable elastic and thermal properties. Some form or wax or suchlike. However polymeric silicone materials have the advantages of being stable, easily handled, non-toxic, inexpensive and suitably compatible.

The sample analog material may have an elastic modulus of less than 5 GPa. The sample analog material may have a Shore A hardness of less than 50, or less than 30.

The sample analog comprises silicone (or some other polymeric solid phase material).

The sample analog may have a thermal conductivity between 0.1 W/m·K and 2 W/m·K at 25° C. The sample analog may have a thermal conductivity of between 0.1 W/m·K and 0.5 W/m·K at 25° C.

The temperature verification device may further comprise a thermal cap, and the body may be attached to the thermal cap.

According to a third aspect, there is provided a method of verifying a temperature measurement for a dynamic light scattering instrument, comprising:
placing a temperature verification device in a sample cell holder;
comparing a temperature measured by the temperature verification device with a temperature measured by the instrument;
verifying that the temperature measured by the dynamic light scattering instrument is representative of the temperature measured by the temperature verification device.

The temperature verification device may be according to the second aspect. The dynamic light scattering instrument and the temperature verification device may together comprise a system according to the first aspect.

The method may further comprise adjusting a temperature readout of the dynamic light scattering instrument until the temperature of the sample measured by dynamic light scattering instrument is within a predefined tolerance of the temperature measured by the temperature verification device.

The method may comprise repeating measurements at a plurality of different temperatures corresponding with a specified range of temperature control for the instrument.

Method features, recited in this summary or in the detailed description, may be applicable to the system or device of the first and/or second aspect. For example, the dynamic light scattering instrument may comprise instructions for causing the dynamic light scattering instrument and/or the temperature verification device to perform any of the method steps described in this specification.

### BRIEF DESCRIPTION OF THE FIGURES

Example embodiments will be described, by way of example only, with reference to the accompanying drawings; in which:

FIG. 1 is a schematic diagram of a dynamic light scattering instrument;

FIG. 2 is a schematic diagram of a system according to an embodiment, comprising the dynamic light scattering instrument of FIG. 1 with a temperature verification device in the sample holder;

FIG. 3 is an illustration of a temperature verification device according to an embodiment; and

FIG. 4 is a flow diagram illustrating the steps of a method according to an embodiment.

Referring to FIG. 1, a dynamic light scattering instrument 200 is shown, comprising a light source 201, light detector 203, sample cell 206, processor 205, temperature sensor 207 and temperature controller 220.

### DETAILED DESCRIPTION OF THE DISCLOSURE

The light source 201 may comprise a laser or a light emitting diode, and illuminates the sample 204 in the sample cell 206 with an illuminating light beam 208 via a focussing lens 222 (which may be moveable so as to adjust a position of a focussed region within the sample cell). An illumination optical fibre 231 and fibre coupling lens 221 (e.g. graded refractive index, GRIN, lens) may be provided between the light source 201 and the focussing lens 222. In other embodiments, the light source 201 may be free space coupled to the focussing lens 222 (e.g. using any appropriate optical elements, including mirrors, prisms, lenses etc). The sample 204 comprises particles suspended in diluent, and the illuminating light beam 208 creates scattered light by its interaction with the particles of the sample 204. Backscattered light is detected by the light detector 203 via a detection optical path 209 which reaches the light detector 203 via the focussing lens 222, coupling lens 223 and detection optical fibre 233. The overlap between the detection optical path 209 and the illuminating light beam 208 defines a scattering region from which scattered light is detected by the detector 203. In some embodiments, more than one detection path may be included (for multi-angle dynamic light scattering).

The sample cell 206 is received in a sample cell holder 210. The sample cell 206 may be a cuvette. The cuvette may consist of a transparent glass or polymeric material. The cuvette may have a square cross section (for example 12.5 mm×12.5 mm, or 10 mm×10 mm, or 8 mm×8 mm). The internal dimensions of a 12.5 mm cuvette may be 10 mm×10 mm (e.g. 1.25 mm wall thickness on each side). The sample cell holder 210 may comprise a cuvette holder, configured to receive a cuvette. The sample cell holder 210 may comprise a resilient element (not shown) configured to urge the sample cell 210 into good thermal contact with the sample cell holder 210.

More complex detection arrangements for DLS are also possible (for example employing more than one detection path, at different angles, for multi-angle DLS). In some embodiments detectors may be provided that receive side-scattered light and/or forward scattered light.

The light detector 203 may be a photon counting detector such as an avalanche photodiode. As already discussed in the background, the output from the detector 201 may be processed by the processor 205 to determine a particle property, such as intensity weighted particle average size (Zaverage), polydispersity, and/or a particle size distribution. Such processing may comprise determining an autocorrelation function from a time history of scattering intensity, determining a diffusion coefficient from the autocorrelation function, and then determining a particle size using the Stokes-Einstein equation (which requires, as an input, the temperature of the sample).

The thermal regulator 220 is configured to control the sample temperature, by heating or cooling the sample cell holder 210 (e.g. in response to control signals from the processor 205). The thermal regulator 220 may comprise a heat sink, thermoelectric device and thermal spreader. The thermoelectric device is operable to cause heating or cooling using the thermoelectric effect (also known as the Peltier effect). The heat sink rejects heat generated by thermoelectric device, and the thermal spreader may be included to ensure that heat flow to and from the thermoelectric device is uniformly applied to the sample holder 210. The thermal spreader may comprise aluminium, or any other material with a high thermal conductivity. Thermal paste or a solid phase thermal pad (e.g. graphite) may be employed between components of the thermal regulator 220, and between the thermal regulator 220 and the sample holder 210.

As described with reference to FIG. 1, the dynamic light scattering instrument 200 may comprise an ambient temperature sensor 228 that measures the ambient temperature near to the sample cell 206.

In some situations, a desired temperature of the sample 204 may be different than the ambient air temperature around the sample cell 206. In such a situation, a temperature gradient may exist between the sample 204 and the temperature sensor 207, because the thermal regulator 220 may be causing heat to flow between the sample and the thermoelectric device to maintain the desired temperature. Greater differences in temperature between the sample 204 and the ambient air will tend to result in larger temperature gradients. This temperature gradient can give rise to an error between the temperature reported by the temperature sensor 207 and the temperature of the sample 204. In order to correct for this, an ambient temperature sensor 228 may be arranged to measure the ambient air temperature in the region of the sample cell 206. The ambient air temperature can be used by the processor 205 to correct for errors in the apparent sample temperature measured by the temperature sensor 207, for example using a lookup table, or a mathematical function modelling a correction. In addition, or alternatively, the ambient air temperature can enable the temperature of the sample to be set to match that of the ambient air, thereby minimising any heat flows.

The instrument 200 may be operable in two modes: i) an ambient corrected temperature mode; and ii) a temperature controlled mode. In the ambient corrected temperature mode, the thermal regulator 220 is set to maintain the temperature of the sample 204 at the same temperature that is measured by the ambient temperature sensor 228. Keeping the sample temperature at the ambient temperature minimises any heat flow between the sample 204 and the ambient environment, and consequently minimises any temperature gradient leading to errors between the temperature measured by the temperature sensor 207 and the true temperature of the sample 204. In the temperature controlled mode, the thermal regulator 220 may be used to set any desired temperature for the sample 204, and the processor may correct for temperature errors as described above. In either mode a predefined tolerance (e.g. 0.5 K) may be defined for the control loop that controls the thermal regulator. In other embodiments a control loop combining at least one of proportional, integral and differential temperature error may be employed to track the target temperature as closely as possible.

The temperature sensor 207 may have a low thermal conductivity path to the sample 204 via the material of the sample cell holder 210 (which may comprise aluminium, for example) and the wall of the sample cell 206 (which may consist of glass and be ˜1.25 mm thick, for example between 0.5 mm and 2 mm thick).

In order for temperature control of the sample 204 to be accurate, it is important that the temperature sensor 207 is accurate (and, in embodiments including it, the ambient temperature sensor 228).

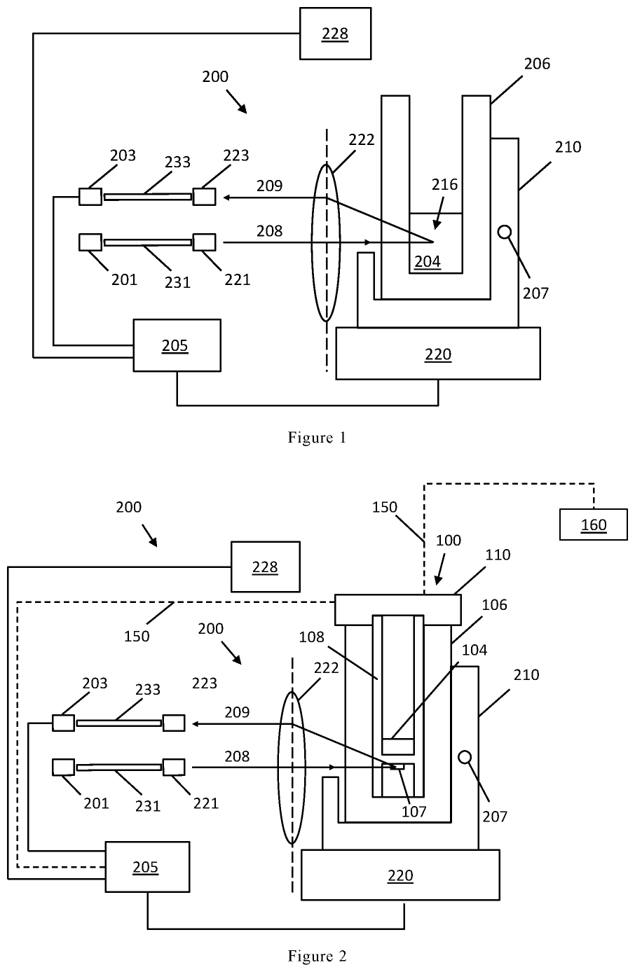

Referring to FIG. 2, the dynamic light scattering instrument 200 shown in FIG. 1 is again illustrated, but a temperature verification 100 device replaces the sample cell 206 in the sample cell holder 210. The temperature verification device 100 may be used to verify that the temperature reading measured by the instrument is an accurate reflection of the temperature of the sample in the scattering volume. In some embodiments, the temperature verification device 100 may be used to calibrate a temperature of the sample determined by the instrument 200 (in dependence on a reading from the temperature sensor 207 and optionally also in dependence on a reading from the ambient temperature sensor 228). This may be done with the light source turned off to avoid direct heating of the sensor 107 by the light source. This may also be performed with the light source on but focussed away from the sample position in order to measure a heating effect of the laser on the sample analog.

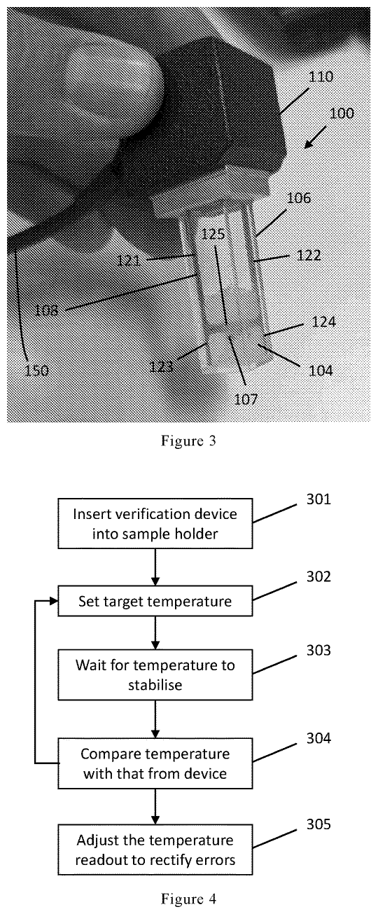

The temperature verification device 100 comprises: sample analog 104, body 106, cap 110, printed circuit board 108, calibrated temperature sensor 107 and lead 150. An example of a temperature verification device 100 is shown in more detail in FIG. 3.

The body 106 may be substantially identical, or at least thermally representative of, the sample cell 206 which is used in the instrument 200 during characterisation of particles. For example, the body 106 may comprise a standard cuvette, made from the same sort of materials that cuvettes for dynamic light scattering measurements are made from (e.g. silica glass, polystyrene, or any other suitable transparent material). Making the body 106 have similar geometry, wall thickness and material to a standard cuvette used for a light scattering analysis may provide for a more representative thermal arrangement in temperature verification.

A cap 110 may be provided, to which the body 106 is attached. The cap 110 may be representative of a thermal cap that is used in the DLS instrument to limit heat loss from the sample cell 206, and its inclusion in the temperature verification device 100 may improve the fidelity with which the thermal verification device 100 simulates a sample cell 206 and sample 204 under measurement conditions. As can be seen most clearly in FIG. 3, the bottom surface of the body 106 and the top surface of the cap 110 are not necessarily parallel. This is a result of the orientation of the sample cell 206 in the instrument 200 in use, which is angled to as to present the vertical wall of the sample cell 206 at a slight angle to the laser, so that the scattering plane in the sample is at a slight angle to the bottom of the sample cell 206. This ensures that any reflection of the illuminating light beam from the external surface of the sample cell 206 can be absorbed, minimising optical noise in the measurement.

The body 106 defines an interior volume of the temperature verification device 100, within which a sample analog 104 is disposed. The sample analog 104 may comprise a material that provides the temperature verification device 100 with thermal properties representative of a sample 204 in a sample cell 206 in normal measurement conditions. For example, the sample analog 104 may comprise material that has a thermal conductivity that is less than that of water, in order to at least partially compensate for the conductive heat path provided by the PCB 108. The steady state thermal properties of the system may be most important to mimic, since the instrument will typically be configured to wait for a temperature to have stabilised for at least a predetermined amount of time before taking a dynamic light scattering measurement. The heat capacity of the sample analog 104 is consequently less important than the thermal conductivity of the sample analog 104 (because heat capacity does not affect steady state heat distribution). In a normal dynamic light scattering measurement, the sample cell 206 will contain a water diluent and nothing will be within the sample cell 206 except the sample 204. The PCB 108 will affect the thermal properties of the device 200, by providing a conductive path from the scattering region to sidewalls of the body 106 and to the cap 110. The sample analog 104 may therefore be selected to have a thermal conductivity lower than that of water. The thermal conductivity of water is ˜0.6 W/m·K at room temperature. The thermal conductivity of the sample analog 104 may be between 0.1 W/m·K and 0.5 W/m·K at 25° C. In an example embodiment, the sample analog 104 may comprise Corning silicone 732 (which has a thermal conductivity of ˜0.2 W/m·K), but other materials can also be used. The sample analog 104 preferably comprises a solid phase material (but this is not essential).

In some embodiments, the sample analog 104 may comprise or consist of a material that is at least semi-transparent, so that a user can visually verify that the calibrated temperature sensor 107 is positioned co-incident with (or at least near to) the scattering region 216. The volume of sample analog 104 in the sample may correspond with a recommended sample quantity used for analysis in the sample cell 206. For example, the volume of the sample analog 104 may be approximately 1 ml, or 0.2 ml to 2 ml. In some embodiments a smaller (or larger) cuvette may be used than ˜1 cm, so a smaller volume may be appropriate.

The printed circuit board 108 is configured to support the calibrated temperature sensor 107 in an appropriate position in the body 106 so that the temperature read by the calibrated temperature sensor 107 corresponds with a temperature in the scattering region. In some embodiments, the calibrated temperature sensor 107 may be positioned at the scattering volume. It is not essential that the calibrated temperature sensor 107 is in exactly the position of the scattering volume, but it is preferable that the calibrated temperature sensor 107 is at a distance of 2 mm or less from the scattering volume (or 3 mm or less). Positioning the calibrated temperature sensor at or near the scattering volume ensures that the temperature monitored by the calibrated temperature sensor is representative of the temperature at the scattering volume during a dynamic light scattering measurement performed on a sample.

The printed circuit board 108 may comprise a U-shape portion, comprising a first vertical leg 121, second vertical leg 122 and a horizontal cross bar 125 between the first and second vertical legs 121, 122. The first vertical leg 121 and the second vertical leg 122 may each be disposed in diagonally opposite corners of the interior volume of the body 106 of the temperature verification device. This locates the PCB 108 relative to the body 106 to a position in the horizontal plane. In order to assist with positioning the calibrated temperature sensor 107 at the correct height so that it measures a temperature representative of the temperature at the scattering volume 216, the printed circuit board may comprise an H-shaped region. The H-shaped region may comprise the U-shaped region as its upper part, and include additional lower legs 123, 124 that continue the vertical legs 121, 122 past the H-shaped region 125 to contact the bottom of the interior volume of the body 106 (thereby vertically locating the calibrated temperature sensor 107 within the body 106). The lower legs comprise a first lower leg 123, continuing (i.e. coaxial with or at least parallel to) the vertical leg 121, and a second lower leg 124, continuing the vertical leg 122.

The calibrated temperature sensor 107 may be a PT100 temperature sensor, comprising a platinum wire configured as a resistor with a nominal 100 ohm resistance (e.g. at 0 degrees C.). Platinum has a well known coefficient of thermal resistivity, and a relatively linear change in resistance with respect to temperature over the temperatures of interest. The calibrated temperature sensor 107 may comprise a thin film PT100 sensor, or a PT100 wire sensor.

For dynamic light scattering, the majority of measurements will be undertaken at temperatures between 0° C. and 100° C. (because the diluent is typically aqueous), and more specifically, most measurements are likely to be taken at room temperature (e.g. 25° C.), fridge temperature (e.g. 4° C.) or body temperature (e.g. 37° C.). In order to accommodate a broader range of measurements, some DLS instruments may be operable at temperatures below 0° C. (e.g. −10° C. or −20° C.) and above 100° C. (e.g. 120° C.), which may be useful where the diluent fluid is not water. In order to accommodate what may be relatively broad temperature specifications for temperature control, it may be necessary that the sample analog 104 is thermally stable at temperatures ranging from −20° C. to 120° C.

The calibrated temperature sensor 107 may have a traceable calibration back to a national calibration standard (e.g. NIST traceable, and/or to ISO/IEC 17025 standard).

In order to take a measurement from a PT100 temperature sensor, it is necessary to determine the resistance of the platinum wire of the sensor. The most accurate measurement of resistance may be achieved used 4 leads. A current may be driven through the PT100 resistor using a first pair of leads, and the voltage over the PT100 resistor may be measured using a second pair of leads. A negligible current flow is needed to determine voltage, so the voltage drop over the PT100 resistor can consequently be measured with high accuracy. In a 2 lead measurement, parasitic resistance (i.e. resistance other than the PT100 resistor) may result in dropped voltages which confound accurate measurement of the voltage dropped over the PT100 resistor. The resistance of the PT100 resistor can be inferred from Ohm's law.

For a 4 lead connection to the PT100 resistor, it is necessary to connect two leads to each end of the PT100 resistor. In the example embodiment a first and second of the leads are connected at a first end of the PT100 resistor, and a third and fourth of the leads are connected at a second end of the PT100 resistor. The four leads may be disposed on both a first side and a second side of the PCB 108. The first lead is formed from a conducting trace on the first side of the first vertical leg 121 and the first side of the horizontal cross bar 125. The second lead is formed from a conducting trace on the second side of the first vertical leg 121 and the second side of the horizontal cross bar 125. The third lead is formed from a conducting trace on the first side of the second vertical leg 122 and the first side of the horizontal cross bar 125. The fourth lead is formed from a conducting trace on the second side of the second vertical leg 122 and the second side of the horizontal cross bar 125. This arrangement of leads enables a minimal width of PCB to be used for the legs 121, 122 and bar 125, thereby minimising disruption to thermal properties arising from the PCB 108.

The arrangement of leads is not essential, and other embodiments may employ a single sided PCB 108 (with conductors on only a single side of the PCB 108), or some other arrangement of leads. The H-shaped arrangement for the printed circuit board 108 is not essential, and in other embodiments the PCB 108 may be configured as a central “wand” that is supported at its root in the cap 110, and which does not make contact with any internal surfaces of the body 106. The use of a printed circuit board 108 as a carrier for the calibrated temperature sensor 107 is not essential—in some embodiments the calibrated temperature sensor 107 may be supported by the sample analog 104 alone, and/or with the aid of suspending wires which are also used to make electrical contact with the calibrated temperature sensor 107.

The PCB 108 may connect with a lead wire 150 in the cap 110. Lead wire 150 carries the 4 leads from the device 100 for connection to an external readout circuit. The external readout circuit is configured to readout the temperature from the calibrated temperature sensor 107. In some embodiments the readout circuit for the thermal verification device may be a separate readout 160 from the dynamic light scattering instrument 200. In other embodiments, the readout circuit for the thermal verification device may be part of the dynamic light scattering instrument 200 (e.g. integrated in the processor 205).

As illustrated in FIG. 4, a verification of the temperature control and readout of a dynamic light scattering instrument 200 may be carried out as follows.
i) Insert the temperature verification device into the sample holder, 301.
ii) Set a target temperature for the sample, 302.
iii) Wait for the dynamic light scattering instrument to indicate that the target temperature has been reached, 303 and optionally wait for an appropriate amount of time for the temperature of the temperature verification device to stabilise (the indicated instrument temperature may stabilise before that of the temperature verification device). iv) Compare the indicated temperature from the DLS instrument (or target temperature, if the readout of temperature is not available) with that indicated by the temperature verification device, 304.
v) Repeat steps ii) to iv) until a sufficient range of temperature values have been verified (e.g. over the range that the instrument indicates in its specification).
and optionally:
vi) If the indicated temperature does not match the temperature indicated by the temperature verification device (to within a predefined tolerance, e.g. 0.5K), adjust the temperature control system and/or temperature readout of the dynamic light scattering instrument to rectify this, 305.

Once any necessary adjustments are performed (if any) the dynamic light scattering instrument 200 may be said to be calibrated (against a standard, since the temperature verification device 100 is also calibrated). A user of the dynamic light scattering instrument 200 and temperature verification device 100 can consequently verify, by a transparently representative test which is traceable to a national calibration standard, that the temperature control of the instrument 200 is working within specifications. Such traceable calibration and verification may be important in some contexts, such as pharmaceutical development.

In some embodiments, the method steps above may be at least partially automated. For example, where the temperature readout for the temperature verification device 100 is performed by the dynamic light scattering instrument, a processor of the dynamic light scattering instrument 200 may control an automatic calibration of the temperature control system using the temperature verification device 100. In other embodiments, a technician may compare set/measured temperatures of the instrument 200 with those of the device 100, and optionally make any adjustments to the instrument 200 manually.

Although an example embodiment has been described in detail, variations are possible, and the scope of the invention should be determined with reference to the accompanying claims.

1. A system, comprising;
an instrument for particle analysis by dynamic light scattering, comprising;
a sample cell holder, configured to receive a sample cell, the sample cell for holding a sample comprising particles suspended in a diluent fluid;
a light source configured to illuminate the sample with a light beam, thereby producing scattered light from the interaction of the light beam with the particles in a scattering region;
a light detector, configured to detect the scattered light from the scattering region and to output scattering data;
a temperature sensor, configured to measure a temperature of the sample cell holder;
a processor configured to receive the scattering data and the measure of temperature of the sample cell holder, and to determine a particle size by performing a dynamic light scattering analysis on the scattering data;
a temperature verification device, comprising:
a body configured to be received in the sample cell holder;
a calibrated temperature sensor within the body, arranged to measure a temperature of the scattering volume.

2. A temperature verification device for checking accuracy of a dynamic light scattering instrument temperature sensor, the temperature verification device comprising:
a body configured to be received in the sample cell holder;
a calibrated temperature sensor within the body at a position corresponding with a scattering volume of the dynamic light scattering instrument.

3. The system of claim 1, wherein the calibrated temperature sensor comprises a thin film PT100 sensor.

4. The system of claim 1, wherein the device further comprises a printed circuit board, the printed circuit board comprising a plurality of conducting traces connecting the calibrated temperature sensor to a connector exterior to the body.

5. The system of claim 4, wherein the body comprises a cuboidal interior volume, and the printed circuit board is disposed corner to corner in the cuboidal interior volume.

6. The system of claim 5, wherein the plurality of traces comprises four traces for performing a four wire measurement of a resistance of the temperature sensor, a first pair of the traces connected to a first end of the temperature sensor, and a second pair of the traces connected to a second end of the temperature sensor.

7. The system of claim 4, wherein the printed circuit board comprises a U-shaped portion, comprising a first vertical leg, a second vertical leg and a horizontal cross bar between the first and second vertical legs.

8. The system of claim 7, wherein the first vertical leg comprises the first pair of the traces, with the first trace of the first pair of traces patterned on a first side of the first vertical leg, and the second trace of the first pair of traces patterned on a second, opposite, side of the first vertical leg, and the second vertical leg comprises the second pair of the traces, with the first trace of the second pair of traces pattered on a first side of the second vertical leg, and the second trace of the second pair of traces pattered on a second, opposite pair of the second vertical leg.

9. The system of claim 8, wherein the printed circuit board comprises an H-shaped portion, the upper region of the H-shaped portion comprising the U-shaped portion, and the lower legs of the H-shaped portion contacting a bottom surface of the body.

10. The system of claim 1, wherein the body comprises a sample cell of the same type that is usable for performing a dynamic light scattering analysis.

11. The system of claim 1, wherein the body is a cuvette.

12. The system of claim 1, wherein the body is 12.5 mm square section cuvette.

13. The system of claim 11, wherein the cuvette is a glass or polystyrene cuvette

14. The system of claim 1, wherein the device comprises a sample analog in which the calibrated temperature sensor is embedded.

15. The system of claim 14, wherein the sample analog has a volume of between 0.5 and 2 ml.

16. The system of claim 14, wherein the sample analog comprises a solid phase polymeric material.

17. The system of claim 16, wherein the sample analog comprises silicone.

18. The system of claim 14, wherein the sample analog has a thermal conductivity of between 0.1 W/m·K and 2 W/m·K at 25° C.

19. The system of claim 1, wherein the temperature verification device further comprises a thermal cap, and the body is attached to the thermal cap.

20. A method of verifying a temperature measurement for a dynamic light scattering instrument, comprising:
placing a temperature verification device in a sample cell holder;
comparing a temperature measured by the temperature verification device with a temperature measured by the instrument;
verifying that the temperature measured by the dynamic light scattering instrument is representative of the temperature measured by the temperature verification device.

21. The method of claim 20, wherein the temperature verification device is a temperature verification device according to any preceding temperature verification device claim, or the dynamic light scattering instrument and the temperature verification device together comprise a system according to any preceding system claim.

22. The method of claim 21, further comprising adjusting a temperature readout of the dynamic light scattering instrument until the temperature of the sample measured by dynamic light scattering instrument is within a predefined tolerance of the temperature measured by the temperature verification device.

23. The method of claim 22, comprising repeating measurements at a plurality of different temperatures corresponding with a specified range of temperature control for the instrument.
